(19) United States
(12) Patent Application Publication
(10) Pub. No.: US 2016/0169002 A1
(43) Pub. Date: Jun. 16, 2016

(54) AIRFOIL TRAILING EDGE TIP COOLING

(71) Applicant: UNITED TECHNOLOGIES CORPORATION, Hartford, CT (US)

(72) Inventors: Wieslaw A. CHLUS, Wethersfield, CT (US); Seth J. THOMEN, Colchester, CT (US)

(21) Appl. No.: 14/908,664

(22) PCT Filed: Jul. 24, 2014
(86) PCT No.: PCT/US2014/047991

§ 371 Date: Jan. 29, 2016

Related U.S. Application Data
(60) Provisional application No. 61/862,171, filed on Aug. 5, 2013.

(51) Int. Cl. F01D 5/18; F02C 7/18

(52) U.S. Cl. CPC F01D 5/186; F02C 7/18

(57) ABSTRACT

An airfoil according to an exemplary aspect of the present disclosure includes, among other things, an airfoil body that includes a first wall and a second wall spaced apart and joined together at each of a leading edge and a trailing edge and extending between a root and a tip. An internal cooling circuit is disposed at least partially inside of the airfoil body. The internal cooling circuit has a first cooling passage disposed near a junction between the tip and the trailing edge and a fanned array of cooling holes that extend between the first cooling passage to at least the tip.

### BACKGROUND

This disclosure relates to a gas turbine engine, and more particularly to a gas turbine engine airfoil having an internal cooling circuit capable of simultaneously cooling a trailing edge and a tip of the airfoil.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Due to exposure to hot combustion gases, numerous components of a gas turbine engine may include internal cooling circuits that circulate airflow to cool the component. Thermal energy is transferred from the component to the airflow as the airflow circulates throughout the cooling circuit to cool the component.

### SUMMARY

An airfoil according to an exemplary aspect of the present disclosure includes, among other things, an airfoil body that includes a first wall and a second wall spaced apart and joined together at each of a leading edge and a trailing edge and extending between a root and a tip. An internal cooling circuit is disposed at least partially inside of the airfoil body. The internal cooling circuit has a first cooling passage disposed near a junction between the tip and the trailing edge and a fanned array of cooling holes that extend between the first cooling passage to at least the tip.

In a further non-limiting embodiment of the foregoing airfoil, the airfoil is a turbine blade.

In a further non-limiting embodiment of either of the foregoing airfoils, the first cooling passage extends to an exit aperture near the trailing edge.

In a further non-limiting embodiment of any of the foregoing airfoils, a second cooling passage is fluidly isolated from the first cooling passage and extends to the trailing edge.

In a further non-limiting embodiment of any of the foregoing airfoils, a first cooling hole of the fanned array of cooling holes extends from the first cooling passage to the trailing edge of the airfoil body and a second cooling hole of the fanned array of cooling holes extends from the first cooling passage to the tip.

In a further non-limiting embodiment of any of the foregoing airfoils, the first cooling hole extends to a position radially outward from an exit aperture of the first cooling passage.

In a further non-limiting embodiment of any of the foregoing airfoils, the first cooling passage extends to a first exit aperture and a second cooling passage extends to a second exit aperture.

In a further non-limiting embodiment of any of the foregoing airfoils, the first exit aperture includes a smaller axial length than the second exit aperture.

In a further non-limiting embodiment of any of the foregoing airfoils, each cooling hole of the fanned array of cooling holes is disposed at a different angle relative to the first cooling passage.

In a further non-limiting embodiment of any of the foregoing airfoils, the internal cooling circuit is configured to cool a trailing edge tip portion of the airfoil body.

In a further non-limiting embodiment of any of the foregoing airfoils, the first cooling passage is a tip flag passage having a radial portion and an axial portion.

In a further non-limiting embodiment of any of the foregoing airfoils, the internal cooling circuit includes a plurality of radially extending cooling holes separate from the fanned array of cooling holes.

A turbine blade according to an exemplary aspect of the present disclosure includes, among other things, a platform and an airfoil that extends from the platform. An internal cooling circuit is disposed inside of the airfoil. The internal cooling circuit comprises a first cooling passage that extends to a first exit aperture positioned near a trailing edge of the airfoil and a second cooling passage that extends to a second exit aperture near the trailing edge. The first exit aperture includes a first axial length different from a second axial length of the second exit aperture.

In a further non-limiting embodiment of the foregoing turbine blade, the internal cooling circuit includes a fanned array of cooling holes that extend from the first cooling passage to a tip of the airfoil.

In a further non-limiting embodiment of either of the foregoing turbine blades, at least two cooling holes of the fanned array of cooling holes extend at a different angle relative to the first cooling passage.

In a further non-limiting embodiment of any of the foregoing turbine blades, the first axial length is smaller than the second axial length.

A method according to another exemplary aspect of the present disclosure includes, among other things, axially communicating a first portion of a coolant through a first cooling passage to cool a trailing edge of an airfoil and communicating a second portion of the coolant through a fanned array of cooling holes to cool a tip of the airfoil.

In a further non-limiting embodiment of the foregoing method, the steps of axially communicating the first portion and communicating the second portion are performed simultaneously.

In a further non-limiting embodiment of either of the foregoing methods, the method includes communicating a third portion of the coolant through at least one cooling hole of the fanned array of cooling holes to cool the trailing edge of the airfoil.

In a further non-limiting embodiment of either of the foregoing methods, the method includes communicating a separate coolant through a second cooling passage of the airfoil.

The embodiments, examples and alternatives of the preceding paragraphs, the claims, or the following descriptions and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a schematic, cross-sectional view of a gas turbine engine.

FIG. 2 illustrates a gas turbine engine airfoil.

FIG. 3 illustrates portions of an internal cooling circuit that can be incorporated into an airfoil.

FIG. 4 illustrates additional features of an internal cooling circuit of a gas turbine engine airfoil.

### DETAILED DESCRIPTION

This disclosure relates to a trailing edge tip cooling configuration for a gas turbine engine airfoil. The internal cooling circuit described by this disclosure may employ a fanned array of cooling holes positioned at a tip of the airfoil in combination with an axially flowing cooling passage that extends to a trailing edge of the airfoil. Among other features, the exemplary internal cooling circuits of this disclosure are configured to simultaneously cool the tip and the trailing edge of an airfoil (i.e., the trailing edge tip portion).

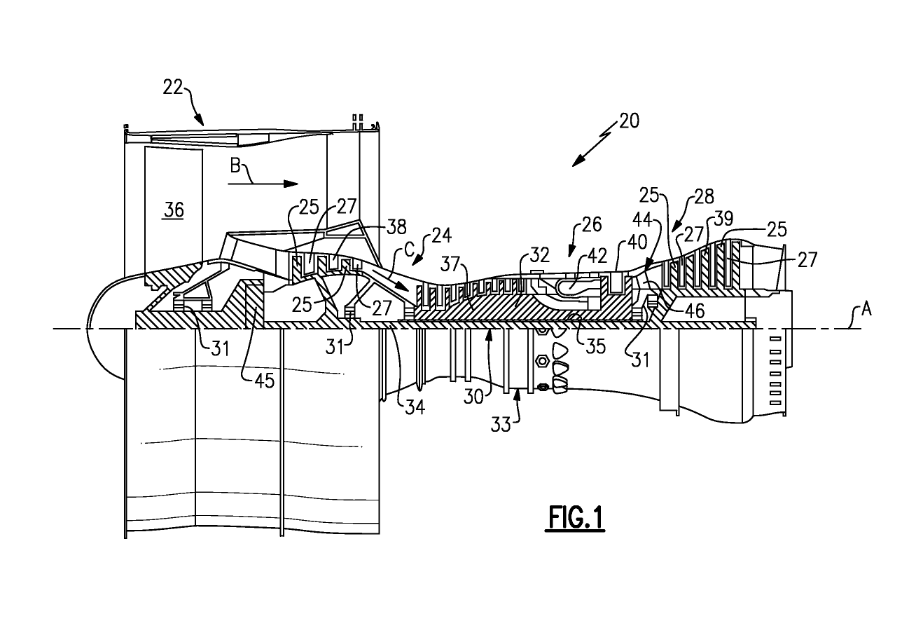

FIG. 1 schematically illustrates a gas turbine engine 20. The exemplary gas turbine engine 20 is a two-spool turbofan engine that generally incorporates a fan section 22, a compressor section 24, a combustor section 26 and a turbine section 28. Alternative engines might include an augmenter section (not shown) among other systems for features. The fan section 22 drives air along a bypass flow path B, while the compressor section 24 drives air along a core flow path C for compression and communication into the combustor section 26. The hot combustion gases generated in the combustor section 26 are expanded through the turbine section 28. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

The gas turbine engine 20 generally includes a low speed spool 30 and a high speed spool 32 mounted for rotation about an engine centerline longitudinal axis A. The low speed spool 30 and the high speed spool 32 may be mounted relative to an engine static structure 33 via several bearing systems 31. It should be understood that other bearing systems 31 may alternatively or additionally be provided.

The low speed spool 30 generally includes an inner shaft 34 that interconnects a fan 36, a low pressure compressor 38 and a low pressure turbine 39. The inner shaft 34 can be connected to the fan 36 through a geared architecture 45 to drive the fan 36 at a lower speed than the low speed spool 30. The high speed spool 32 includes an outer shaft 35 that interconnects a high pressure compressor 37 and a high pressure turbine 40. In this embodiment, the inner shaft 34 and the outer shaft 35 are supported at various axial locations by bearing systems 31 positioned within the engine static structure 33.

A combustor 42 is arranged between the high pressure compressor 37 and the high pressure turbine 40. A mid-turbine frame 44 may be arranged generally between the high pressure turbine 40 and the low pressure turbine 39. The mid-turbine frame 44 can support one or more bearing systems 31 of the turbine section 28. The mid-turbine frame 44 may include one or more airfoils 46 that extend within the core flow path C.

The inner shaft 34 and the outer shaft 35 are concentric and rotate via the bearing systems 31 about the engine centerline longitudinal axis A, which is co-linear with their longitudinal axes. The core airflow is compressed by the low pressure compressor 38 and the high pressure compressor 37, is mixed with fuel and burned in the combustor 42, and is then expanded over the high pressure turbine 40 and the low pressure turbine 39. The high pressure turbine 40 and the low pressure turbine 39 rotationally drive the respective high speed spool 32 and the low speed spool 30 in response to the expansion.

The pressure ratio of the low pressure turbine 39 can be pressure measured prior to the inlet of the low pressure turbine 39 as related to the pressure at the outlet of the low pressure turbine 39 and prior to an exhaust nozzle of the gas turbine engine 20. In one non-limiting embodiment, the bypass ratio of the gas turbine engine 20 is greater than about ten (10:1), the fan diameter is significantly larger than that of the low pressure compressor 38, and the low pressure turbine 39 has a pressure ratio that is greater than about five (5:1). It should be understood, however, that the above parameters are only exemplary of one embodiment of a geared architecture engine and that the present disclosure is applicable to other gas turbine engines, including direct drive turbofans.

In this embodiment of the exemplary gas turbine engine 20, a significant amount of thrust is provided by the bypass flow path B due to the high bypass ratio. The fan section 22 of the gas turbine engine 20 is designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of [Tram° R)/(518.7° R)]^{0.5}. The Low Corrected Fan Tip Speed according to one non-limiting embodiment of the example gas turbine engine 20 is less than about 1150 fps (351 m/s).

Each of the compressor section 24 and the turbine section 28 may include alternating rows of rotor assemblies and vane assemblies (shown schematically) that carry airfoils that extend into the core flow path C. For example, the rotor assemblies can carry a plurality of rotating blades 25, while each vane assembly can carry a plurality of vanes 27 that extend into the core flow path C. The blades 25 create or extract energy (in the form of pressure) from the core airflow that is communicated through the gas turbine engine 20 along the core flow path C. The vanes 27 direct the core airflow to the blades 25 to either add or extract energy.

Various components of the gas turbine engine 20, including but not limited to the airfoil and platform sections of the blades 25 and vanes 27 of the compressor section 24 and the turbine section 28, may be subjected to repetitive thermal cycling under widely ranging temperatures and pressures. The hardware of the turbine section 20 is particularly subjected to relatively extreme operating conditions. Therefore, some components may require dedicated internal cooling circuits to cool the parts during engine operation. This disclosure relates to internal cooling circuits that may be incorporated into airfoils, and more particularly, to internal cooling circuits effective for cooling a trailing edge tip portion of an airfoil.

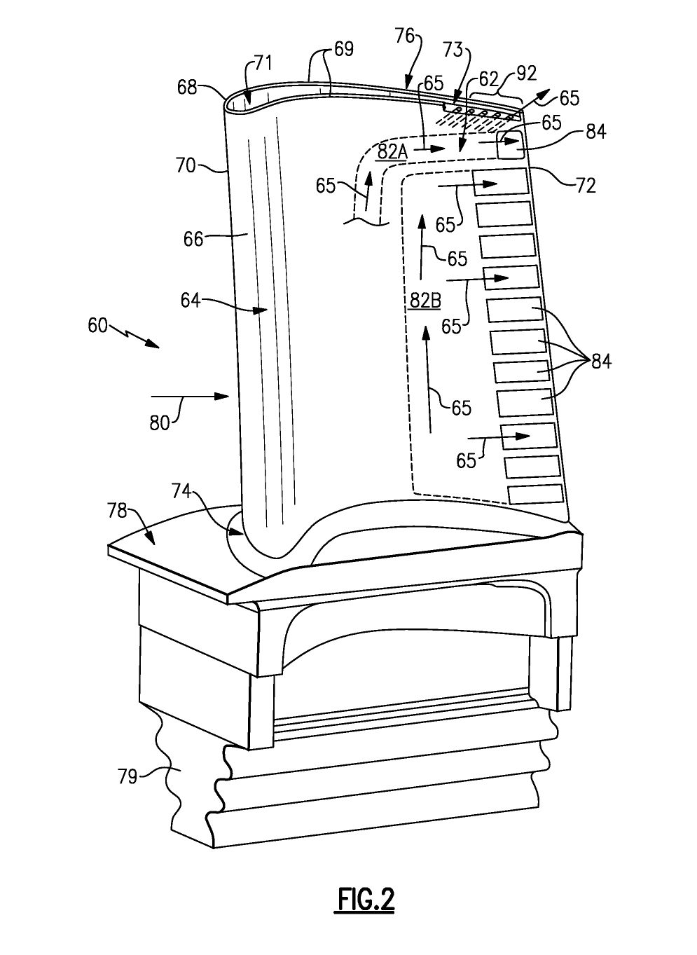

FIG. 2 illustrates an airfoil 60 having an internal cooling circuit 62 (schematically shown in phantom) for circulating a coolant 65, such as relatively cool air from the compressor section 24, to cool portions of the airfoil 60. In one embodiment, the airfoil 60 is a turbine blade of the turbine section 28 (see FIG. 1). However, this disclosure is not limited to blades and could extend to vanes or any other gas turbine engine components that utilize or require dedicated internal cooling circuits. Although a single airfoil 60 is shown, a plurality of airfoils could be annularly assembled side-by-side with their respective inboard platforms 78 forming a ring bounding an inboard portion of the core flow path C (see FIG. 1).

The airfoil 60 includes an airfoil body 64 that defines an external and internal shape with respect to the passages, cavities and other openings established by the internal cooling circuit 62. The airfoil body 64 includes a first wall 66 (i.e., a pressure sidewall) and a second wall 68 (i.e., a suction sidewall) that are spaced apart from one another and joined at each of a leading edge 70 and a trailing edge 72. The airfoil body 64 extends in chord between the leading edge 70 and the trailing edge 72 and spans between a root 74 and a tip 76.

The airfoil body 64 may extend from a platform 78. The platform 78 includes a feature 79 (e.g., a root portion) configured to be received by a disk as is known in the art. The root 74 of the airfoil body 64 is positioned at the platform 78 and the tip 76 is spaced from the platform 78.

Each of the first wall 66 and the second wall 68 extend to a rim 69 at the tip 76 of the airfoil body 64. The tip 76 may define a tip plenum 71 that extends radially inward from the rims 69 of the first wall 66 and the second wall 68. In one embodiment, the first wall 66 includes a cut-back 73 in which a portion of the rim 69 is removed.

A gas path 80 may be communicated axially downstream through the gas turbine engine 20 along the core flow path C (FIG. 1) in a direction that extends from the leading edge 70 toward the trailing edge 72 of the airfoil body 64. The gas path 80 is schematically represented by an arrow and is representative of the communication of core airflow across the airfoil body 64.

The exemplary internal cooling circuit 62 may include multiple cooling passages (or cavities) formed inside the airfoil body 64, portions of which are schematically shown as 82A, 82B (hereafter the “first cooling passage 82A” and the “second cooling passage 82B”). The internal cooling circuit 62 may include additional cavities or passages than are illustrated and that radially, axially and/or circumferentially extend inside of the airfoil body 64 to establish conduits for channeling the coolant 65 to cool the airfoil body 64. The coolant 65 may include airflow or some other fluid. Portions of the coolant 65 may be expelled from the internal cooling circuit 62 via one or more exit apertures 84 disposed along the trailing edge 72 of the airfoil body 64. One or more exit apertures 84 may be associated with each cooling passage 82A, 82B.

The internal cooling circuit 62 may additionally include one or more cooling holes 92 disposed near the tip 76 of the airfoil body 64. Portions of the coolant 65 may also be discharged through the cooling holes 92 to cool the tip 76.

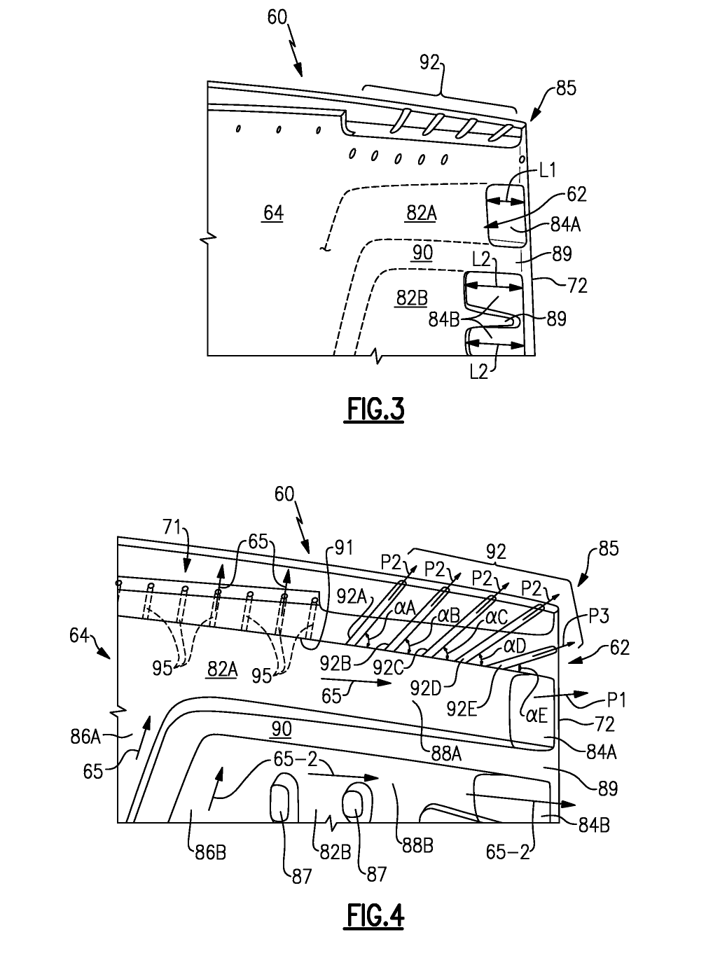

FIGS. 3 and 4 illustrate one exemplary internal cooling circuit 62 that can be incorporated into the airfoil 60 of FIG. 2, or some other component. In one exemplary embodiment, the internal cooling circuit 62 includes at least a first cooling passage 82A and a second cooling passage 82B that is fluidly isolated from the first cooling passage 82A. A rib 90 may be disposed between the first cooling passage 82A and the second cooling passage 82B to fluidly isolate the passages from one another. It should be understood that any number of cooling passages could be arranged to extend inside of the airfoil body 64.

The cooling passages 82A, 82B may be hollow cavities formed inside of the airfoil body 64. In one non-limiting embodiment, the first cooling passage 82A is a tip flag passage and the second cooling passage 82B is an aft-most cooling passage of the airfoil 60. Other configurations are contemplated as within the scope of this disclosure. The cooling passages 82A, 82B are configured to cool at least a trailing edge tip portion 85, and potentially other portions, of the airfoil body 64.

The first cooling passage 82A may include a radial portion 86A for radially communicating a coolant 65 and an axial portion 88A for axially communicating the coolant 65 through the internal cooling circuit 62 (see FIG. 4). In one embodiment, the first cooling passage 82A, which can be referred to as a tip flag passage, is positioned at a junction between the tip 76 and the trailing edge 72 of the airfoil body 64 (that is, within the trailing edge tip portion 85).

The second cooling passage 82B may similarly include radial portions 86B and axial portions 88B for channeling a separate coolant 65-2 near the trailing edge 72 of the airfoil body 64. One or more augmentation features 87, such as pins or pedestals, may additionally be positioned within the second cooling passage 82B to increase heat transfer between the coolant 65-2 and the airfoil 60.

The first cooling passage 82A extends to an exit aperture 84A positioned at the trailing edge 72 of the airfoil body 64. The coolant 65 may be expelled from the first cooling passage 82A through the exit aperture 84A. The second cooling passage 82B may extend to a plurality of exit apertures 84B disposed along the trailing edge 72 for expelling the coolant 65-2 therefrom. In one embodiment, the exit apertures 84A, 84B are widows or slots formed in the trailing edge 72. The exit apertures 84A, 84B may be separated from one another by a tab of material 89 of the airfoil body 64. The tab of material 89 may be part of the rib 90.

In one embodiment, best shown in FIG. 3, the exit aperture 84A of the first cooling passage 82A includes an axial length L1 and the exit aperture(s) 84B of the second cooling passage 82B include an axial length L2. The axial length L1 may be different from the axial length L2. In one non-limiting embodiment, the axial length L1 is smaller than the axial length L2 in order to accommodate cooling holes of the internal cooling circuit 62, as discussed in greater detail below. However, other configurations are also contemplated. The exit aperture 84A may also be radially wider than the exit apertures 84B to increase the surface area available for heat exchange at the trailing edge tip portion 85.

The internal cooling circuit 62 may additionally include a fanned array of cooling holes 92 position near the trailing edge tip portion 85 of the airfoil body 64. The fanned array of cooling holes 92 may include any number of cooling holes embodying any size or shape. In one non-limiting embodiment, the fanned array of cooling holes 92 includes five cooling holes 92A-92E (see FIG. 4). Each cooling hole 92A-92E is in fluid communication with, and fans outward from, the first cooling passage 82A. The cooling holes 92A through 92E may be generally non-parallel and non-equidistantly spaced from one another.

Each of the cooling holes 92A-92E of the fanned array of cooling holes 92 may be disposed at a different angle relative to the first cooling passage 82A. In one embodiment, the cooling holes 92A-92E progressively fan out so that an angle α_{A}. E between their axes and an outer wall 91 of the first cooling passage 82A decreases between the cooling hole 92A and the cooling hole 92E. In another embodiment, at least two of the cooling holes 92A-92E extend at a different angle relative to the first cooling passage 82A. The angles α_{A-E} may be any angle between zero and 90 degrees, which can be customized to address different cooling needs.

In one embodiment, the cooling hole 92E of the fanned array of cooling holes 92 includes an inlet at the first cooling passage 82A and an outlet at the trailing edge 72 of the airfoil body 64. The cooling holes 92A-92D include inlets at the first cooling passage 82A and outlets that open to the tip 76. In this way, the fanned array of cooling holes 92 can simultaneously cool the trailing edge 72 and the tip 76 of the airfoil body 64. The reduced axial length L1 (see FIG. 3) of the exit aperture 84A creates enough space to accommodate extension of the cooling hole 92E to the trailing edge 72 at a location radially outward from the exit aperture 84A.

Optionally, one or more radially extending cooling holes 95 may be disposed between the first cooling passage 82A and the tip plenum 71 as part of the internal cooling circuit 62. The radially extending cooling holes 95 are separate from the fanned array of cooling holes 92. Coolant 65 may be communicated through the radially extending cooling holes 95 to cool those portions of the tip 76 remote from the trailing edge tip portion 85.

The first cooling passage 82A and the fanned array of cooling holes 92 are capable of simultaneously cooling the tip 76 and trailing edge 72 of the airfoil body 64. In other words, these portions of the internal cooling circuit 62 are configured to efficiently cool the trailing edge tip portion 85 of the airfoil 60.

For example, in use, a first portion P1 of coolant 65 may be axially communicated through the first cooling passage 82A and expelled from the exit aperture 84A in order to cool the trailing edge 72 of the airfoil body 64. A second portion P2 of the coolant 65 may be communicated, simultaneously with the first portion P1, through the fanned group of cooling holes 92 to cool the tip 76 of the airfoil body 64 in conjunction with the trailing edge 72.

In another embodiment, a third portion P3 of the coolant 65 may be communicated through at least one cooling hole (in this example, the cooling hole 92E) of the fanned array of cooling holes 92 to cool the trailing edge 72 of the airfoil body 64. Communication of the third portion P3 of the coolant 65 enables cooling of hot spots that may exist radially outwardly from the exit aperture 84A at the trailing edge tip portion 85. Optionally, a separate coolant 65-2 may be communicated through the second cooling passage 82B to cool additional portions of the trailing edge 72, such as portions that are radially inward from the trailing edge tip portion 85.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An airfoil, comprising:
an airfoil body that includes a first wall and a second wall spaced apart and joined together at each of a leading edge and a trailing edge and extending between a root and a tip;
an internal cooling circuit disposed at least partially inside of said airfoil body, said internal cooling circuit having:
a first cooling passage disposed near a junction between said tip and said trailing edge; and
a fanned array of cooling holes that extend between said first cooling passage to at least said tip.

2. The airfoil as recited in claim 1, wherein said airfoil is a turbine blade.

3. The airfoil as recited in claim 1, wherein said first cooling passage extends to an exit aperture near said trailing edge.

4. The airfoil as recited in claim 1, comprising a second cooling passage fluidly isolated from said first cooling passage and extending to said trailing edge.

5. The airfoil as recited in claim 1, wherein a first cooling hole of said fanned array of cooling holes extends from said first cooling passage to said trailing edge of said airfoil body and a second cooling hole of said fanned array of cooling holes extends from said first cooling passage to said tip.

6. The airfoil as recited in claim 5, wherein said first cooling hole extends to a position radially outward from an exit aperture of said first cooling passage.

7. The airfoil as recited in claim 1, wherein said first cooling passage extends to a first exit aperture and comprising a second cooling passage extending to a second exit aperture.

8. The airfoil as recited in claim 7, wherein said first exit aperture includes a smaller axial length than said second exit aperture.

9. The airfoil as recited in claim 1, wherein each cooling hole of said fanned array of cooling holes is disposed at a different angle relative to said first cooling passage.

10. The airfoil as recited in claim 1, wherein said internal cooling circuit is configured to cool a trailing edge tip portion of said airfoil body.

11. The airfoil as recited in claim 1, wherein said first cooling passage is a tip flag passage having a radial portion and an axial portion.

12. The airfoil as recited in claim 1, wherein said internal cooling circuit includes a plurality of radially extending cooling holes separate from said fanned array of cooling holes.

13. A turbine blade, comprising:
a platform;
an airfoil that extends from said platform;
an internal cooling circuit disposed inside of said airfoil, said internal cooling circuit comprising:
a first cooling passage that extends to a first exit aperture positioned near a trailing edge of said airfoil;
a second cooling passage that extends to a second exit aperture near said trailing edge; and
wherein said first exit aperture includes a first axial length different from a second axial length of said second exit aperture.

14. The turbine blade as recited in claim 13, wherein said internal cooling circuit includes a fanned array of cooling holes that extend from said first cooling passage to a tip of said airfoil.

15. The turbine blade as recited in claim 14, wherein at least two cooling holes of said fanned array of cooling holes extend at a different angle relative to said first cooling passage.

16. The turbine blade as recited in claim 13, wherein said first axial length is smaller than said second axial length.

17. A method, comprising:
axially communicating a first portion of a coolant through a first cooling passage to cool a trailing edge of an airfoil; and
communicating a second portion of the coolant through a fanned array of cooling holes to cool a tip of the airfoil.

18. The method as recited in claim 17, wherein the steps of axially communicating the first portion and communicating the second portion are performed simultaneously.

19. The method as recited in claim 17, comprising communicating a third portion of the coolant through at least one cooling hole of the fanned array of cooling holes to cool the trailing edge of the airfoil.

20. The method as recited in claim 17, comprising communicating a separate coolant through a second cooling passage of the airfoil.
